(19) United States
(12) Patent Application Publication
(10) Pub. No.: US 2012/0060151 A1
(43) Pub. Date: Mar. 8, 2012

(54) SYSTEM AND METHOD FOR UPDATING FIRMWARE

(75) Inventors: Jung Hwan OH, Seoul (KR); Jae Seong PARK, Daejeon (KR)

(73) Assignee: LSIS CO., LTD.

(21) Appl. No.: 13/215,108

(22) Filed: Aug. 22, 2011

(30) Foreign Application Priority Data
Sep. 3, 2010 (KR) 10-2010-0086739

(51) Int. Cl. G06F 9/44

(52) U.S. Cl. 717/170; 717/172

(57) ABSTRACT

The present disclosure can update firmware of home electronic devices using an energy meter installed at each energy consumer house. The energy meter receives firmware from a remote server managing the firmware of home electronic devices and transmits the firmware to home electronic devices. The energy meter may bypass the firmware of the home electronic devices received from the remote server, or pre-download and transmit to the home electronic devices at a time the update is to be implemented.

Pursuant to 35 U.S.C.§119 (a), this application claims the benefit of earlier filing date and right of priority to Korean Patent Application No. 10-2010-0086739, filed on Sep. 3, 2010, the contents of which are hereby incorporated by reference in their entirety.

### BACKGROUND OF THE DISCLOSURE

1. Field

Exemplary embodiments of the present disclosure may relate to a system and a method for updating firmware, and more particularly to a system and a method for updating firmware for use in home electrical appliances.

2. Background

The firmware is a computer program or a binary image file embedded in a device, stored in a storage unit such as flash ROM of the device itself. Currently, many devices are special-purpose computers, executing specific firmware for functionality thereof. Many types of electronic devices, including standalone and peripheral device, operate using some form of firmware, program instruction.

Firmware updates are required to fix bugs in the firmware, addressing functionality issues, and/or improving the performance and reliability of a device after the device is shipped. Conventionally, firmware updates must be manually performed using a software tool by users under an OS (Operating System) environment. In this method, users must understand software tools, and have related update technical knowledge. For general users, however, conventional firmware updates are complicated and inconvenient.

In general, firmware provides various settings and algorithms that specify how an electronic device should operate and how the device should communicate with other devices. Firmware is typically stored in the electronic device using some type of non-volatile memory and loaded into a working memory of the device upon power-up or enabling of the electronic device. Once the firmware is loaded, the electronic device performs operations according to the firmware. Although some types of electronic devices have been designed to allow firmware to be upgraded or updated in the field to improve performance of the device (e.g., computer motherboard bios), other types of electronic devices generally require specialized hardware for performing such upgrades or updates.

There may be three updating methods of firmware for electronic devices, that is, visiting, by an operator, to each home for updating, taking the electronic device, by a user, to a dealer or a manufacturer for updating, and downloading, by the user, firmware through communication networks such as Internet.

The first method has a disadvantage in that an operator must visit each home in person causing the user to spend time and expenses, and the second method is also disadvantageous in that the user is given much inconvenience as the electronic device must be personally taken to a dealer or a manufacturer for updating.

Concomitant with popularization of Internet services, the third method may come into focus for upgrading the firmware. However, the third method is not easy job either for ordinary people to upgrade the firmware as many Internet users are not fully aware of the updating method using Internet. Still worse is that it is cumbersome for the user to personally update the firmware, and it is not easy to propagate to many users the fact that it is necessary to update the firmware and the method on how to upgrade the firmware.

That is, although the third method technically seems convenient to the user, it is not that easy to update the electronic devices in the home. Attempts to upgrade firmware and/or software in electronic devices are often hampered by the limited user interaction capabilities of the device, and the slow communication speeds available. End-user interactions cannot be relied upon, as they can be erroneous. As a result, needs for developing a new effective firmware updating method on many electronic devices in the house have been required.

### SUMMARY OF THE DISCLOSURE

The present disclosure is directed to a system and a method for updating firmware configured to solve the aforementioned disadvantages by providing no trouble to a user and enabling the user to easily update electric appliances disposed at each home.

Technical subjects to be solved by the present disclosure are not restricted to the above-mentioned description, and any other technical problems not mentioned so far will be clearly appreciated from the following description by the skilled in the art.

In one general aspect of the present disclosure, there is provided a system for updating firmware, the system comprising: a remote server generating and managing firmware of a home electronic device; an energy meter receiving the firmware from the remote server through a first communication network; and the home electronic device receiving the firmware from the energy meter through a second communication network, wherein the remote server transmits the firmware to the energy meter through the first communication network, the energy meter transmits the received firmware to the electronic device through the second communication network, and the electronic device checks if there is any default in the received firmware and operates using the received firmware.

Preferably, the energy meter measures an amount of use in any one of electricity, gas and city water.

Preferably, the energy meter includes metering means calculating an amount of energy supplied to a load, storage means recording the calculated amount of energy and information necessary for operation of the energy meter; first communication means transmitting data to the remote server and receiving data from the remote server, and second communication means transmitting data to the home electronic device and receiving data from the home electronic device, wherein the firmware of home electronic device is downloaded from the remote server through the first communication means and recorded in the storage means, and the downloaded firmware is transmitted to the home electronic device through the second communication means.

Preferably, the energy meter records a history of firmware update of the home electronic device in the storage means.

Preferably, the energy meter further includes time checking means measuring a current time.

Preferably, the energy meter downloads the firmware of the home electronic device and update time information from the remote server through the first communication means and records in the storage means, and transmits the firmware recorded in the storage means to the home electronic device through the second communication means, if the current time measured by the time checking means becomes update time recorded in the storage means.

Preferably, the current time measured by the time checking means can be adjusted, and the current time adjustment by the time checking means can be realized by communication with other devices, or personally set up by a user through a user interface disposed at the energy meter.

Preferably, the home electronic device comprises communication means receiving firmware from the energy meter, a memory storing the received firmware, and a processor checking if there is any fault in the firmware and operating the received firmware.

Preferably, the home electronic device further comprises storage means recording and storing currently operating firmware information including at least version and update time.

Preferably, the home electronic device records in the storage means an attempted firmware update and a history of result of the update attempt.

Preferably, the home electronic device operates in response to operation environment pre-set prior to the firmware update, even if the firmware has been updated.

Preferably, the firmware is configured per module capable of performing an individual update, wherein the firmware update of the home electronic device is independently implemented for each module.

In another general aspect of the present disclosure, there is provided a method for updating firmware, the method comprising: transmitting, by a remote server generating and managing firmware of a home electronic device, the firmware to an energy meter through a first communication network; receiving, by the energy meter, the firmware transmitted from the remote server, and transmitting the firmware to the home electronic device through a second communication network; receiving, by the home electronic device, the firmware transmitted from the energy meter and updating the firmware of the home electronic device using the received firmware.

Preferably, the energy meter measures an amount of use in any one of electricity, gas and city water.

Preferably, the method further comprises recording a history related to performance of firmware update of the home electronic device.

In still another aspect of the present disclosure, there is provided a method for updating firmware, the method comprising: transmitting, by a remote server generating and managing firmware of a home electronic device, the firmware and update time information of the firmware to an energy meter through a first communication network; receiving and storing, by the energy meter, the firmware transmitted from the remote server and the update time information and monitoring whether a current time is the update time; transmitting, by the energy meter, the firmware stored by receiving from the remote server to the electronic device through a second communication network, if the current time becomes the update time; and receiving, by the home electronic device, the firmware transmitted from the energy meter and updating the firmware of the home electronic device using the received firmware.

The system and method for updating firmware according to the present disclosure has an advantageous effect in that an energy meter installed at each energy consumer receives update information on firmware of an electronic device from a remote server, and performs the firmware update of the electronic device using a method of re-transmitting the update information of the firmware to the electronic device, whereby a user is not personally involved in a process of downloading new firmware and performing updating, such that the user can update the firmware by being freed from inconvenience related to firmware update, and a package update in time for a plurality of electronic devices can be enabled.

The system and method for updating firmware according to the present disclosure has another advantageous effect in that, concomitant with a trend of an energy meter being replaced by a smart meter capable of communicating with a remote server, there is no need of separately setting up an infrastructure for receiving and transmitting firmware update information between the remote server and energy meters of each energy consumer.

The system and method for updating firmware according to the present disclosure has another advantageous effect in that there is no need of transmitting firmware of home electronic devices at one time to enable dispersion of communication traffic and to prevent an excessive load from being applied to a remote server, because an energy meter can receive firmware update information in advance and perform the update in time for relevant time points.

Furthermore, the system and method for updating firmware according to the present disclosure can be used as a general firmware update scheme to various electronic devices, because an energy meter can be installed at any place where a user uses the electronic devices.

### BRIEF DESCRIPTION OF THE DRAWINGS

Accompanying drawings are included to provide a further understanding of arrangements and embodiments of the present disclosure and are incorporated in and constitute a part of this application. Now, non-limiting and non-exhaustive exemplary embodiments of the disclosure are described with reference to the following drawings, in which

FIG. 1 is a schematic conceptual view illustrating a system for updating firmware of home electronic devices according to an exemplary embodiment of the present disclosure;

FIG. 2 is a mimetic diagram illustrating firmware update for home electronic devices being performed through a firmware update system according to the present disclosure;

FIG. 3 is a schematic view illustrating a configuration of home electronic devices in a system for updating firmware according to the present disclosure;

FIG. 4 is a conceptual view of firmware update;

FIGS. 5 and 6 are views illustrating a method for updating firmware of home electronic devices according to exemplary embodiments of the present disclosure;

FIG. 7 is a conceptual view illustrating an energy meter in a system for updating firmware according to an exemplary embodiment of the present disclosure;

FIG. 8 is a flowchart illustrating an operation process of an energy meter in a system for updating firmware according to an exemplary embodiment of the present disclosure;

FIG. 9 is a conceptual view illustrating an energy meter in a system for updating firmware according to another exemplary embodiment of the present disclosure; and

FIG. 10 is a flowchart illustrating an operation process of an energy meter in a system for updating firmware according to another exemplary embodiment of the present disclosure.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the method particularly pointed out in the written description and claims hereof as well as the appended drawings.

### DETAILED DESCRIPTION

Hereinafter, exemplary embodiments of the present disclosure are described in detail with reference to the accompanying drawings. It will be appreciated that for simplicity and/or clarity of illustration, elements illustrated in the figure have not necessarily been drawn to scale. For example, the dimensions of some of the elements may be exaggerated relative to other elements for clarity. Further, if considered appropriate, reference numerals have been repeated among the figures to indicate corresponding and/or analogous elements.

Particular terms may be defined to describe the disclosure in the best mode as known by the inventors. Accordingly, the meaning of specific terms or words used in the specification and the claims should not be limited to the literal or commonly employed sense, but should be construed in accordance with the spirit and scope of the disclosure. The definitions of these terms therefore may be determined based on the contents throughout the specification.

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled”, and “connected” may mean that two or more elements do not contact each other but are indirectly joined together via another element or intermediate elements.

Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

In the following description and/or claims, the terms “comprise” and “include,” along with their derivatives, may be used and are intended as synonyms for each other. Furthermore, the terms “including”, “includes”, “having”, “has”, “with”, or variants thereof are used in the detailed description and/or the claims to denote non-exhaustive inclusion in a manner similar to the term “comprising”.

Words such as “thereafter,” “then,” “next,” etc. are not intended to limit the order of the processes; these words are simply used to guide the reader through the description of the methods. The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

In describing the present disclosure, detailed descriptions of constructions or processes known in the art may be omitted to avoid obscuring appreciation of the invention by a person of ordinary skill in the art with unnecessary detail regarding such known constructions and functions.

Now, the system and method for updating firmware according to the present disclosure will be described in detail with reference to the accompanying drawings.

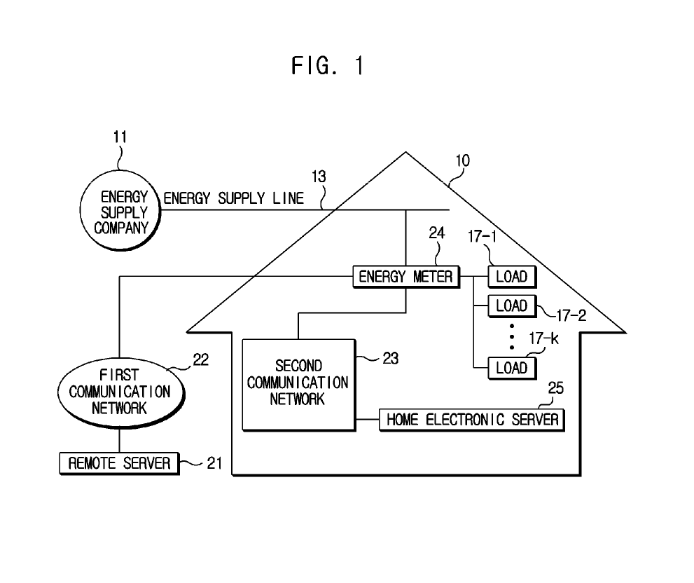

FIG. 1 is a schematic conceptual view illustrating a system for updating firmware (hereinafter referred to as “firmware update system”) of home electronic devices according to an exemplary embodiment of the present disclosure.

Referring to FIG. 1, an energy supply company (11) supplies energy to each energy consumer through an energy supply line (13). An energy meter (24) is installed at each energy consumer for measuring energy use consumed by loads (17-1 17-k) of a relevant energy consumer (10) by being connected to the energy supply line (13).

In the present disclosure, the term of energy means any one of electricity, gas and city water, and the energy meter (24) may mean a watt meter, a gas meter or a water meter.

The energy consumer (10) is equipped with an electronic device (25) having various types and functions. The electronic device (25) installed at each energy consumer (10) may be called as ‘a home electronic device’. Although FIG. 1 illustrates one home electronic device (25), it should be apparent that the one home electronic device (25) includes a plurality of electronic devices.

The home electronic device (25) may be or may not be a load in relation with the energy meter (24). In a non-limiting example, in a case the energy meter (24) is a watt meter, and the load is a home electronic device using an electric energy supplied through the energy supply line (13), the home electronic device becomes a load. However, in a case the energy meter (24) is a gas meter, and the home electronic device (25) is not a device consuming gas, the home electronic device (25) is not a load in relation to the energy meter (24).

That is, there is no need for the home electronic device (25) to be a device associated with the energy meter (24) in relation to energy supplied to the energy consumer (10).

A firmware update system for a home electronic device according to the present disclosure includes a remote server (21) generating or managing firmware of the home electronic device, an energy meter (24) receiving the firmware of the home electronic device from the remote server (24), and a home electronic device (25) receiving firmware from the energy meter (24). The remote server (21) and the energy meter (24) exchanges information related to firmware update through a first communication network (22).

Furthermore, the energy meter (24) and the home electronic device (25) exchanges information related to firmware update through a second communication network (23). The first and second communication networks (22, 23) may be various types of communication networks. In a non-limiting example, the first and second communication networks (22, 23) may be bidirectional communication networks. To be more specific, the first communication network (22) may be WAN (Wide Area Network) including a wired Internet network or a wireless Internet network, and the second communication network (23) may be a wired or wireless HAN (Home Area Network) including Zigbee communication network or a power line communication network.

The remote server (21) serves to generate or manage firmware of the home electronic device (25), and to transmit the firmware of the home electronic device (25) to the energy meter (24). The energy meter (24) may be variably configured based on types of energies and required functions. The energy meter (24) basically measures energy consumption consumed by the loads (17-1 17-k) of the energy consumer (10) by being connected to the energy supply line (13).

The measured information may be used in various fields including, but not limited to, for calculating a consumed energy rate or providing various energy-related analysis information to users. Particularly, the energy meter (24), in relation to the present disclosure, transmits to the home electronic device (25) firmware of the home electronic device received from the remote server (21). The home electronic device (25) is operated by firmware, where the firmware defines a program instruction controlling operation of electronic devices.

Generally, the firmware is stored in a ROM (Read Only Memory) and maintained regardless of power supply. The firmware according to the present disclosure can be updated at any time, and the home electronic device (25) maintains firmware in the ROM.

Furthermore, the home electronic device (25), if received with new firmware from the energy meter (24), updates the currently used firmware to new firmware received from the energy meter (24).

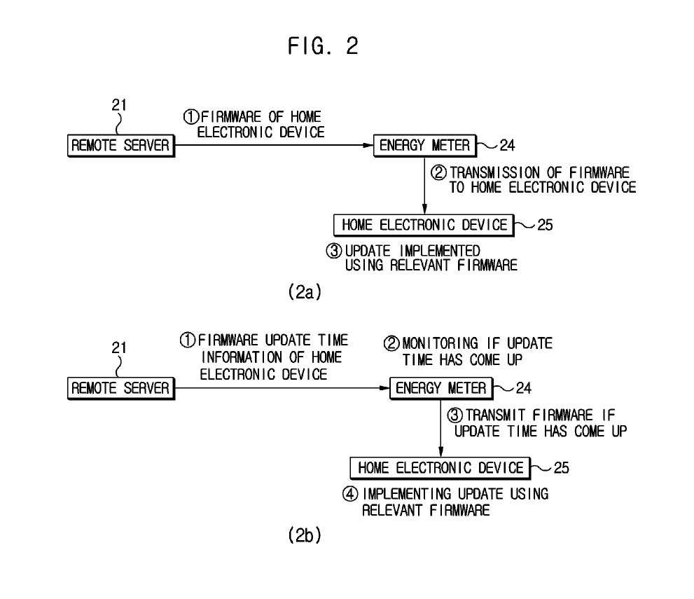

FIG. 2 is a mimetic diagram illustrating firmware update for home electronic devices being performed through a firmware update system according to the present disclosure.

Referring to FIG. 2, each exemplary embodiment will be described in which a firmware update of home electronic device (25) is implemented through the firmware update system according to the present disclosure.

Referring to FIG. 2a, the remote server (21) transmits firmware of the home electronic device (25) to the energy meter (24), where the energy meter (24) transmits the received firmware to the home electronic device (25) as is, and where the home electronic device (25) updates the firmware received from the energy meter (24).

That is, the energy meter (24) bypasses the firmware received from the remote server (21) directly to the home electronic device (25).

Referring to FIG. 2b, the remote server (21) transmits update time information to the energy meter (24) along with the firmware of the home electronic device, where the update time defines a future time when the firmware of the home electronic device (25) is to be updated.

The energy meter (24) stores the firmware received from the remote server (21) and the update time information for a while. Thereafter, the energy meter (24) monitors if a relevant update time has come up, and if it is determined that the relevant update time has come up, the energy meter (24) transmits the stored firmware to the home electronic device (25), where the home electronic device (25) implements the updating using the firmware received from the energy meter (24). That is, the energy meter (24) pre-downloads the firmware of the home electronic device (25), and updates the home electronic device (25) at a time when the update is to be implemented.

The energy meter (24) can record and manage a history related to implementation of firmware update of the home electronic device (25). The history information may be variably used. In a non-limiting example, the energy meter (24) may transmit the relevant history information to the remote server (21) to check if there is any updated or recent firmware on the home electronic device (25), download the recent firmware from the remote server (21) as a result of the checking, and transmit the downloaded recent firmware to the home electronic device (25).

Meanwhile, the firmware may be formed in modules capable of performing various functions based on various functions implemented by the home electronic device (25). At this time, the firmware may be configured to be entirely updated at all times, or may be configured to be individually updated for each module.

In case of the firmware of the home electronic device (25) being formed in modules of individual update, the remote server (21) can generate firmware for each module or manage firmware for each module. At this time, the remote server (21) can transmit the firmware to the energy meter (24) for each module, and the update time information can be also transmitted for each module. Then, the firmware update of home electronic device (25) can be implemented for each module.

As noted above, the firmware update of home electronic device can be implemented in whole or in module unit, such that the term of “firmware” of the present disclosure also has a meaning of a module capable of updating an entire firmware and capable of individually updating the firmware as well.

The energy meter (24) or the home electronic device (25) can check if the received firmware is free from any fault (hereinafter referred to as “integrity check”), once the firmware is received, where the expression of integrity check is to check whether firmware has been all received normally.

The integrity of an update is very important, because applying a faulty or even intentionally manipulated update could render the device useless.

The firmware can be transmitted along with bibliographic information such as types, number of firmware and size for integrity check, and the energy meter (24) and the home electronic device (25) can compare the bibliographic information with the received firmware to check the integrity.

As a result of the integrity check, if the firmware has not been received normally, the energy meter (24) can communicate with the remote server (21) to receive a relevant firmware again, and the home electronic device (25) can communicate with the energy meter (24) to receive the relevant firmware again.

The home electronic device (25) is not limited in types thereof as long as firmware is received from the energy meter (24) through the second communication network (23) to implement the firmware update by itself. Particularly, the home electronic device (25) may be an in-home display installed at the energy consumer (10) to display various information related to energy.

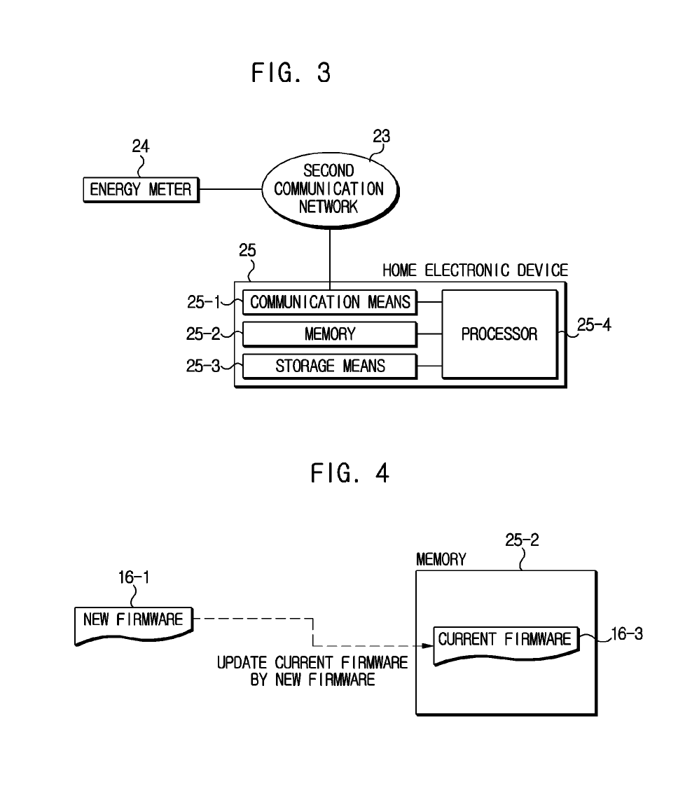

FIG. 3 is a schematic view illustrating a configuration of home electronic devices in a system for updating firmware according to the present disclosure. Referring to FIG. 3, a detailed exemplary embodiment of the home electronic device (25) will be described.

As noted from the foregoing, the types of home electronic device (25) are not restricted. Therefore, although not explicitly illustrated, the home electronic device (25) may be variably configured to implement intrinsic functions.

Communication means (25-1) is configured to communicate with the energy meter (24) through the second communication network (23). For example, the communication means (25-1) may be configured to communicate with the energy meter (24) using various wired/wireless communication methods including Zigbee communication method or PLC (Power Line Communication) method.

A memory (25-2) is a constituent element for storing and maintaining firmware, and generally includes a ROM. Storage means (25-3) is a non-volatile storage medium to store various information necessary for operation of the home electronic device (25).

A processor (25-4) implements an overall control of the home electronic device (25) by being operated with the firmware stored in the memory (25-2), and may be configured using a microprocessor or a CPU (Central Processing Unit). Particularly, the processor (25-4) checks the integrity of the firmware received from the energy meter (24) through the communication means (25-1), and update a currently used firmware using a new firmware received from the energy meter (24). The term of implementing or performing update means that the home electronic device (25) is so processed as to be operated on a new firmware.

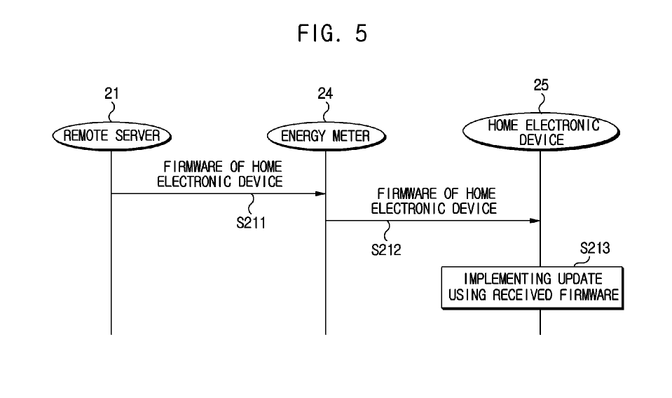

That is, as illustrated in FIG. 4, a current firmware (16-3) stored in the memory (25-2) is updated to a new firmware (16-1) received from the energy meter (24). If the new firmware is recorded in the memory (25-2), the home electronic device (25) is thereafter operated based on content of the new firmware.

At this time, the processor (25-4) may maintain, without any change, information including an operation environment pre-set up before the update, e.g., environment information set up by a user, and a communication environment with the energy meter (24), even after the firmware has been updated.

Furthermore, the processor (25-4) may record and store currently operating firmware information, firmware update attempt and a history related to a result of the update attempt. Firmware information to be stored may include version information and update time, and stored information may be confirmed or checked by a user and the energy meter (24).

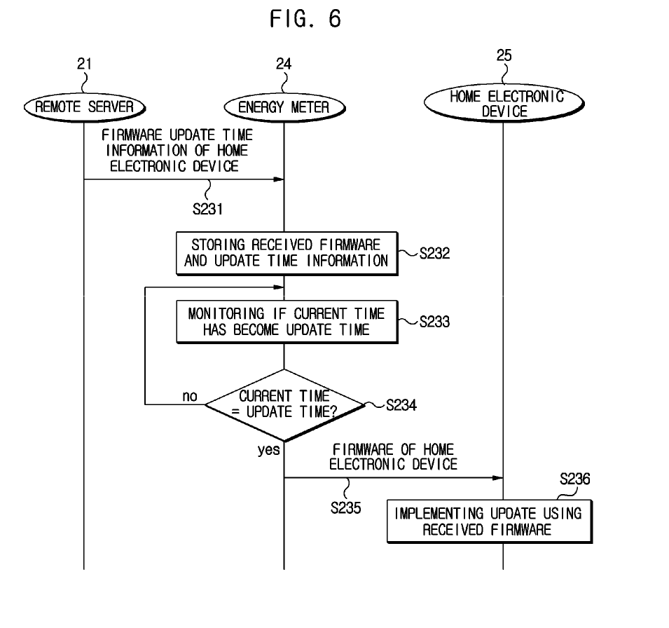

FIGS. 5 and 6 are views illustrating a method for updating firmware of home electronic devices according to exemplary embodiments of the present disclosure. Referring to FIGS. 5 and 6, various exemplary embodiments of a method for updating firmware (hereinafter referred to as “firmware update method”) will be described.

FIG. 5 is an exemplary embodiment where the energy meter (24) bypasses firmware received from the remote server (21) to the home electronic device (25).

First, the remote server (21) generating and managing the firmware of the home electronic device (25) transmits a new firmware to the energy meter (24) through the first communication network (22) (S211). The energy meter (24) receives the firmware transmitted from the remote server (21), and transmits the firmware to the home electronic device (25) through the second communication network (23) (S212).

At this time, the energy meter (24) may check the integrity of the firmware received from the remote server (21), and as a result of the check, if it is determined that the firmware has not been normally received, communication may be made with the remote server (21) to receive a relevant firmware again.

The home electronic device (25) receives the firmware transmitted from the energy meter (24), and updates its firmware using the received firmware (S213). At this time, the home electronic device (25) may check the integrity of the received firmware, and as a result of the check, if it is determined that the firmware has not been normally received, communication may be made with the energy meter (24) to receive a relevant firmware again.

FIG. 6 is an exemplary embodiment where the energy meter (24) transmits the firmware received from the remote server (21) to the home electronic device (25) in time for a future time.

First, the remote server (21) generating and managing the firmware of the home electronic device (25) transmits to the energy meter (21) through the first communication network (22) a new firmware and update time information which is a future time in which the new firmware will operate (S231).

At this time, the energy meter (24) may check integrity of firmware received from the remote server (21), and as a result of the check, if it is determined that the firmware has not been normally received, communication may be made with the remote server (21) to receive a relevant firmware again. The energy meter (24) stores the firmware received from the remote server (21) and the update time information (S232).

Now, the energy meter (24) checks whether a current time has become the update time (S233). If the current time has become the update time as a result of the check (S234), the energy meter (24) transmits the firmware stored in the Step 232 to the home electronic device (25) through the second communication network (23) (S235). The home electronic device (25) receives the firmware transmitted from the energy meter (24), and updates its firmware using the received firmware (S236).

At this time, the home electronic device (25) may check integrity of the received firmware, and as a result of the check, if it is determined that the firmware has not been normally received, communication may be made with the energy meter (24) to receive a relevant firmware again.

The home electronic device (25) at the Step S236 may keep an operation environment as it is, even after the firmware update including environment information set up by a user or a communication environment with the energy meter (24).

The energy meter (24) records a history related to update of firmware of the home electronic device through Step S212 of FIG. 5 or S235 of FIG. 6, that is, firmware version information and time information, in its storage means (24-4, described later) and manages the history. The firmware information to be stored may include version and update time.

These pieces of information may be variably utilized. In a non-limiting example, inquiry of firmware update history of the home electronic device by the user, the energy meter (24) or the remote server (21), or the information capable of notifying failed attempt of update may allow the home electronic device (25) to attempt the update of the relevant firmware again.

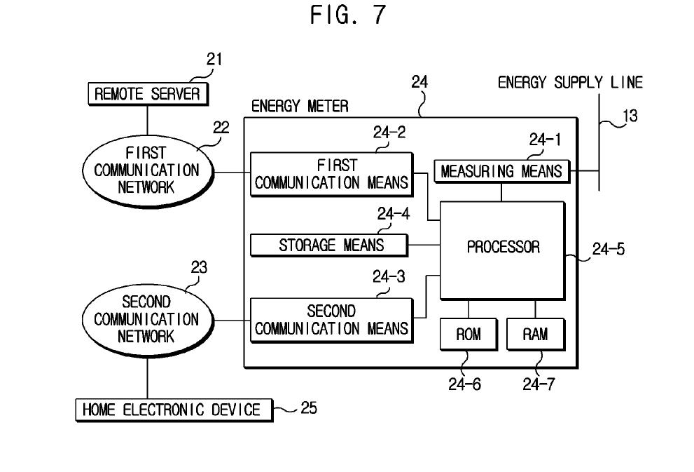

FIG. 7 is a conceptual view illustrating an energy meter in a system for updating firmware according to an exemplary embodiment of the present disclosure, where the energy meter (24) includes measuring means (24-1), first communication means (24-2), second communication means (24-3), storage means (24-4), a processor (24-5), a ROM (Read Only Memory, 24-6), and a RAM (Random Access Memory, 24-7).

The measuring means (24-1) measures energy consumption (i.e., amount of consumed energy) of a relevant energy consumer by being connected to an energy supply line (13). The energy consumption measured by the measuring means (24-1) may be stored in the storage means (24-4) and managed, or although not illustrated, the energy consumption may be displayed by a display device capable of displaying energy consumption.

The first communication means (24-2) may communicate with the remote server (21) through the first communication network (22). In a non-limiting example, the first communication means (24-2) may be a modem capable of being connected to a WAN (Wide Area Network) including a wired Internet network or a wireless Internet network.

The second communication means (24-3) may communicate with the home electronic device (25) through the second communication network (23). In a non-limiting example, the second communication means (24-3) may be configured to communicate by using various wired/wireless communication methods including Zigbee communication method or PLC (Power Line Communication) method.

The first and second communication means (24-2, 24-3) may be mutually combined together based on types of the first and second communication networks (22, 23).

The storage means (24-4) is a non-volatile storage medium capable of reading and writing digital data, and stores and keeps various information necessary for energy consumption measured by the measuring means (24-1) and operation of the energy meter (24).

The ROM (24-6) stores a driving program of the energy meter (24), and the RAM (24-7) temporarily stores data immediately accessible by the processor (24-5).

The processor (24-5) may be configured using a microprocessor or a CPU (Central Processing Unit), and generally controls the energy meter (24) by operating in response to a driving program stored in the ROM (24-6). Particularly, the processor (24-5) transmits the firmware received from the remote server (21) through the first communication means (22) to the home electronic device (25) through the second communication means (24-3).

At this time, the processor (24-5) periodically accesses the remote server (21) through the first communication means (24-2) to check if there is a new firmware for the home electronic device (25), and requests that the new firmware be downloaded to the remote server (21), if there is available new firmware.

Furthermore, if there is a new firmware for the home electronic device (25), the remote server (21) may inform the energy meter (24) of the availability of the new firmware, whereby the processor (24-5) may download the firmware of the home electronic device (25) through the first communication means (24-2). The processor (24-5) may check the integrity of the firmware received from the first communication means (24-2), and as a result of the check, if it is determined that the firmware has not been normally received, communication may be made with the remote server (21) to receive a relevant firmware again.

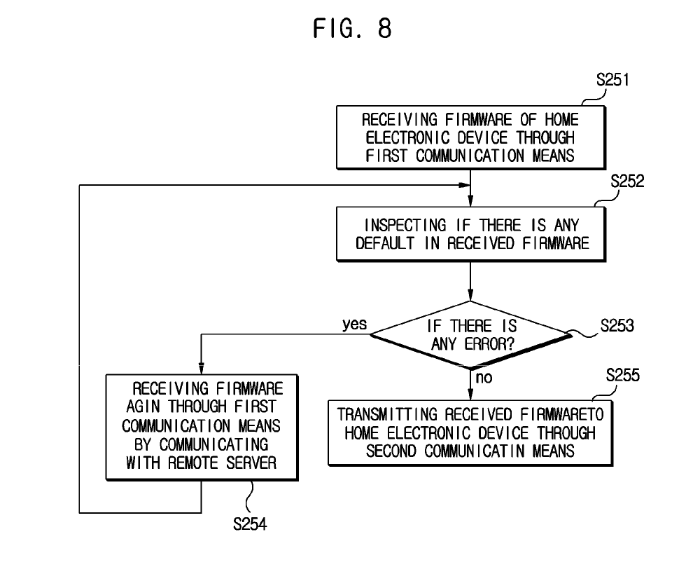

FIG. 8 is a flowchart illustrating an operation process of an energy meter in a system for updating firmware according to an exemplary embodiment of the present disclosure. Referring to FIG. 8, an exemplary operation will be described in which the energy meter (24) illustrated in FIG. 7 implements the firmware update of home electronic device.

First, in a case firmware of the home electronic device (25) is received through the first communication means (24-2) (S251), the processor (24-5) checks the integrity of the received firmware (S252).

As a result of the check on the integrity (S253), if the firmware has not been normally received, the processor (24-5) communicates with the remote server (21) through the first communication means (24-2) to receive a relevant firmware again (S254).

However, if it is determined that the firmware has been normally received as a result of the check on the integrity (S253), the processor (24-5) transmits the received firmware to the home electronic device (25) (S255), whereby the firmware update can be implemented by the home electronic device (25).

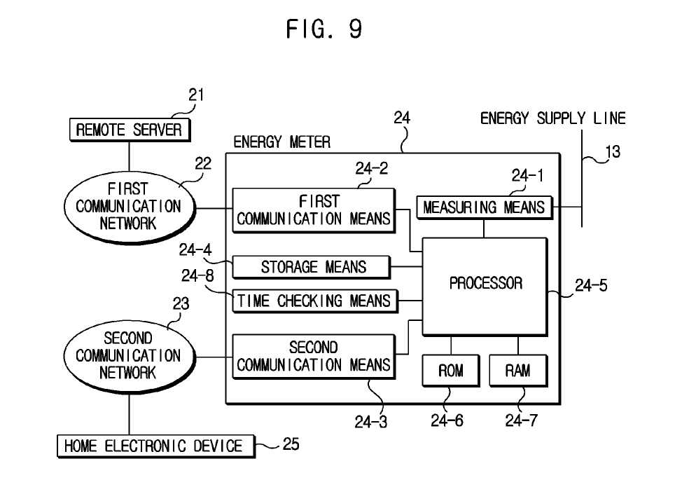

FIG. 9 is a conceptual view illustrating an energy meter in a system for updating firmware according to another exemplary embodiment of the present disclosure, where the energy meter (24) includes measuring means (24-1), first communication means (24-2), second communication means (24-3), storage means (24-4), a processor (24-5), a ROM (Read Only Memory, 24-6), a RAM (Random Access Memory, 24-7) and time check means (24-8).

The measuring means (24-1) measures energy consumption (i.e., amount of consumed energy) of a relevant energy consumer by being connected to an energy supply line (13). The energy consumption measured by the measuring means (24-1) may be stored in the storage means (24-4) and managed, or although not illustrated, the energy consumption may be displayed by a display device capable of displaying energy consumption.

The first communication means (24-2) may communicate with the remote server (21) through the first communication network (22). In a non-limiting example, the first communication means (24-2) may be a modem capable of being connected to a WAN (Wide Area Network) including a wired Internet network or a wireless Internet network.

The second communication means (24-3) may communicate with the home electronic device (25) through the second communication network (23). In a non-limiting example, the second communication means (24-3) may be configured to communicate by using various wired/wireless communication methods including Zigbee communication method or PLC (Power Line Communication) method.

The first and second communication means (24-2, 24-3) may be mutually combined together based on types of the first and second communication networks (22, 23).

The storage means (24-4) is a non-volatile storage medium capable of reading and writing digital data, and stores and keeps various information necessary for energy consumption measured by the measuring means (24-1) and operation of the energy meter (24).

The time check means (24-8) measures a current time, where a method of measuring the current time may be variably configured. In a non-limiting example, the time check means (24-8) may measure the current time using a RTC (Real Time Clock). The current time measured by the time check means (24-8) may generate an error, such that the current time may be configured to be adjusted.

The adjustment of current time may be implemented by communication with other devices including the remote server (21), or may be configured by a direct set-up by a user. In the latter case, the energy meter (24) may include a user interface capable of displaying a current time measured by the time check means (24-8) and adjusting the time by the user.

The ROM (24-6) stores a driving program of the energy meter (24), and the RAM (24-7) temporarily stores data immediately accessible by the processor (24-5).

The processor (24-5) may be configured using a microprocessor or a CPU (Central Processing Unit), and generally controls the energy meter (24) by operating in response to a driving program stored in the ROM (24-6). Particularly, the processor (24-5) transmits the firmware received from the remote server (21) through the first communication means (24-2) to the home electronic device (25) through the second communication means (24-3).

At this time, the processor (24-5) periodically accesses the remote server (21) through the first communication means (24-2) to check if there is a new firmware for the home electronic device (25), and requests that the new firmware be downloaded to the remote server (21), if there is available new firmware.

Furthermore, if there is a new firmware for the home electronic device (25), the remote server (21) may inform the energy meter (24) of the availability of the new firmware, whereby the processor (24-5) may download the firmware of the home electronic device through the first communication means (24-2). The processor (24-5) may check the integrity of the firmware received from the first communication means (24-2), and as a result of the check, if it is determined that the firmware has not been normally received, communication may be made with the remote server (21) to receive a relevant firmware again.

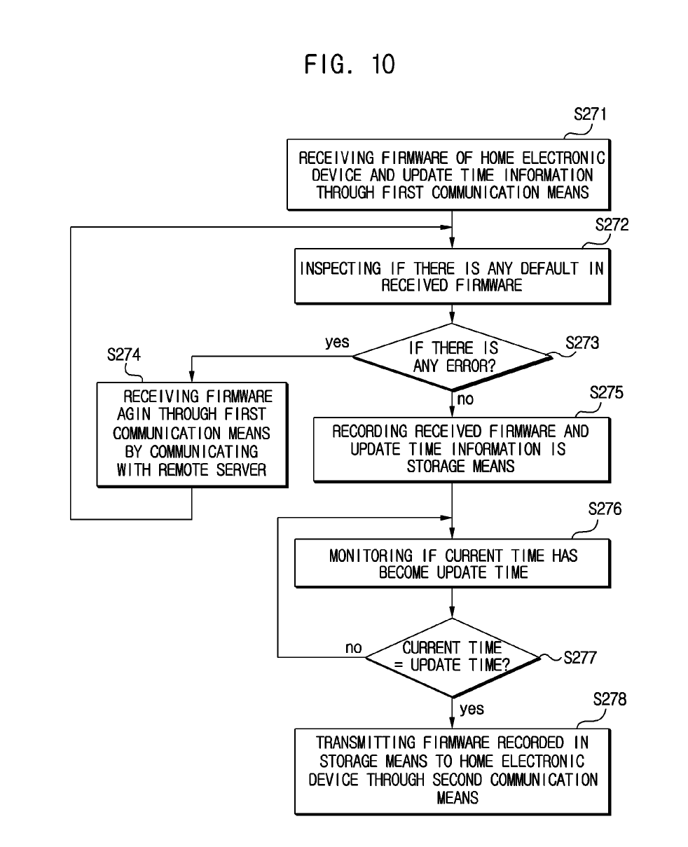

FIG. 10 is a flowchart illustrating an operation process of an energy meter in a system for updating firmware according to another exemplary embodiment of the present disclosure. Referring to FIG. 10, an exemplary operation will be described in which the energy meter (24) illustrated in FIG. 9 implements the firmware update of home electronic device.

First, in a case firmware and update time information of the home electronic device (25) are received through the first communication means (24-2) (S271), the processor (24-5) checks the integrity of the received firmware (S272).

As a result of the check on the integrity (S273), if the firmware has not been normally received, the processor (24-5) communicates with the remote server (21) through the first communication means (24-2) to receive a relevant firmware again (S274).

However, if it is determined that the firmware has been normally received as a result of the check on the integrity (S273), the processor (24-5) stores the firmware and the update time information received from the remote server (21) in the storage means (24-4) (S275).

Now, the processor (24-5) monitors whether update time has come up by using the current time information measured by the time check means (24-8) (S276).

If it is determined as a result of the check (S277) that the current time has become the update time, the firmware stored in the storage means (24-4) at the Step S275 is transmitted to the home electronic device (25) through the second communication means (24-3) (S278).

The system and method for updating firmware according to the present disclosure may, however, be embodied in many different forms and should not be construed as limited to the embodiments set forth herein. Thus, it is intended that embodiments of the present disclosure may cover the modifications and variations of this disclosure provided they come within the scope of the appended claims and their equivalents.

While particular features or aspects may have been disclosed with respect to several embodiments, such features or aspects may be selectively combined with one or more other features and/or aspects of other embodiments as may be desired.

What is claimed is:

1. A system for updating firmware, the system comprising: a remote server generating and managing firmware of a home electronic device; an energy meter receiving the firmware from the remote server through a first communication network; and the home electronic device receiving the firmware from the energy meter through a second communication network, wherein the remote server transmits the firmware to the energy meter through the first communication network, the energy meter transmits the received firmware to the home electronic device through the second communication network, and the home electronic device checks if there is any default in the received firmware and operates using the received firmware.

2. The system of claim 1, wherein the energy meter measures an amount of use in any one of electricity, gas and city water.

3. The system of claim 1, wherein the energy meter includes metering means calculating an amount of energy supplied to a load, storage means recording the calculated amount of energy and information necessary for operation of the energy meter; first communication means transmitting data to the remote server and receiving data from the remote server, and second communication means transmitting data to the home electronic device and receiving data from the home electronic device, wherein the firmware of home electronic device is downloaded from the remote server through the first communication means and recorded in the storage means, and the downloaded firmware is transmitted to the home electronic device through the second communication means.

4. The system of claim 3, wherein the energy meter records a history of firmware update of the home electronic device in the storage means.

5. The system of claim 3, wherein the energy meter further includes time checking means measuring a current time.

6. The system of claim 5, wherein the energy meter downloads the firmware of the home electronic device and update time information from the remote server through the first communication means and records in the storage means, and transmits the firmware recorded in the storage means to the home electronic device through the second communication means, if the current time measured by the time checking means becomes update time recorded in the storage means.

7. The system of claim 5, wherein the current time measured by the time checking means can be adjusted and the current time adjustment by the time checking means can be realized by communication with other devices, or personally set up by a user through a user interface disposed at the energy meter.

8. The system of claim 1, wherein the home electronic device comprises communication means receiving firmware from the energy meter, a memory storing the received firmware, and a processor checking if there is no fault in the firmware and operating the received firmware.

9. The system of claim 8, wherein the home electronic device further comprises storage means recording and storing currently operating firmware information including at least version and update time.

10. The system of claim 9, wherein the home electronic device records in the storage means an attempted firmware update and a history of result of the update attempt.

11. The system of claim 1, wherein the home electronic device operates in response to operation environment pre-set prior to the firmware update, even if the firmware has been updated.

12. The system of claim 1, wherein the firmware is configured per module capable of performing an individual update, wherein the firmware update of the home electronic device is independently implemented for each module.

13. A method for updating firmware, the method comprising: transmitting, by a remote server generating and managing firmware of a home electronic device, the firmware to an energy meter through a first communication network; receiving, by the energy meter, the firmware transmitted from the remote server, and transmitting the firmware to the home electronic device through a second communication network; receiving, by the home electronic device, the firmware transmitted from the energy meter and updating the firmware of the home electronic device using the received firmware.

14. The method of claim 13, wherein the energy meter measures an amount of use in any one of electricity, gas and city water.

15. The method of claim 13, wherein the method further comprises recording a history related to performance of firmware update of the home electronic device.

16. A method for updating firmware, the method comprising: transmitting, by a remote server generating and managing firmware of a home electronic device, the firmware and update time information of the firmware to an energy meter through a first communication network; receiving and storing, by the energy meter, the firmware transmitted from the remote server and the update time information and monitoring whether a current time is the update time; transmitting, by the energy meter, the firmware stored by receiving from the remote server to the home electronic device through a second communication network, if the current time becomes the update time; and receiving, by the home electronic device, the firmware transmitted from the energy meter and updating the firmware of the home electronic device using the received firmware.
